(19) United States
(12) Patent Application Publication
(10) Pub. No.: US 2021/0312506 A1
(43) Pub. Date: Oct. 7, 2021

(54) INFORMATION PROCESSING APPARATUS, VEHICLE, INFORMATION PROCESSING SYSTEM, PROGRAM, AND INFORMATION PROCESSING METHOD

(71) Applicant: TOYOTA JIDOSHA KABUSHIKI KAISHA, Toyota-shi (JP)

(72) Inventors: Xin JIN, Nagoya-shi (JP); Takayuki Murase, Toyota-shi (JP); Tadahiro Kashiwai, Nagoya-shi (JP); Toru Takashima, Susono-shi (JP); Hiroaki Hanzawa, Toyota-shi (JP); Hideo Hasegawa, Nagoya-shi (JP)

(73) Assignee: TOYOTA JIDOSHA KABUSHIKI KAISHA, Toyota-shi (JP)

(21) Appl. No.: 17/178,772

(22) Filed: Feb. 18, 2021

(30) Foreign Application Priority Data
Apr. 1, 2020 (JP) 2020-066156

(51) Int. Cl. G06Q 30/02; G06K 9/00

(52) U.S. Cl. CPC G06Q 30/0273; G06Q 30/0266; G06K 9/00369; G06K 9/00791

(57) ABSTRACT

An information processing apparatus includes a control unit configured to acquire imaging data obtained by capturing an image of surroundings of a vehicle traveling while presenting an advertisement, and to calculate an advertising fee of the advertisement based on the imaging data.

### CROSS-REFERENCE TO RELATED APPLICATION

This application claims priority to Japanese Patent Application No. 2020-066156 filed on Apr. 1, 2020, incorporated herein by reference in its entirety.

### BACKGROUND

### 1. Technical Field

The present disclosure relates to an information processing apparatus, a vehicle, an information processing system, a program, and an information processing method.

### 2. Description of Related Art

One example of a well-known advertising method is placing an advertisement on a side of a vehicle and showing the advertisement to pedestrians.

For example, Japanese Unexamined Patent Application Publication No. 2012-118106 discloses a technology in which a light emitting diode plate is installed on a side of a vehicle and advertisement information is displayed so as to scroll across the light emitting diode plate.

### SUMMARY

In a case where a vehicle is traveling while presenting the advertisement, the effect of the advertisement depends on the number of pedestrians walking in the vicinity of the vehicle, but an advertising fee is often fixed.

The present disclosure is for correlating the fee of the advertisement presented on the vehicle with the effect of the advertisement.

An information processing apparatus according to the present disclosure includes a control unit configured to acquire imaging data obtained by capturing an image of surroundings of a vehicle traveling while presenting an advertisement, and to calculate an advertising fee of the advertisement based on the imaging data.

A program according to the present disclosure causes a computer to execute acquiring imaging data obtained by capturing an image of surroundings of a vehicle traveling while presenting an advertisement, and calculating an advertising fee of the advertisement based on the imaging data.

An information processing method according to the present disclosure is used in an information processing apparatus. The information processing method includes a step of acquiring imaging data obtained by capturing an image of surroundings of a vehicle traveling while presenting an advertisement, and a step of calculating an advertising fee of the advertisement based on the imaging data.

With the present disclosure, it is possible to correlate the fee of the advertisement presented on the vehicle with the effect of the advertisement.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a configuration of an information processing system according to an embodiment of the present disclosure;

FIG. 2 is a block diagram illustrating a configuration of an information processing apparatus according to the embodiment of the present disclosure;

FIG. 3 is a block diagram illustrating a configuration of a vehicle according to the embodiment of the present disclosure;

FIG. 4 is a flowchart illustrating an operation of the information processing system according to the embodiment of the present disclosure; and

FIG. 5 is a flowchart illustrating an operation of the information processing system according to the embodiment of the present disclosure.

### DETAILED DESCRIPTION OF EMBODIMENTS

Hereinafter, embodiments of the present disclosure will be described with reference to drawings.

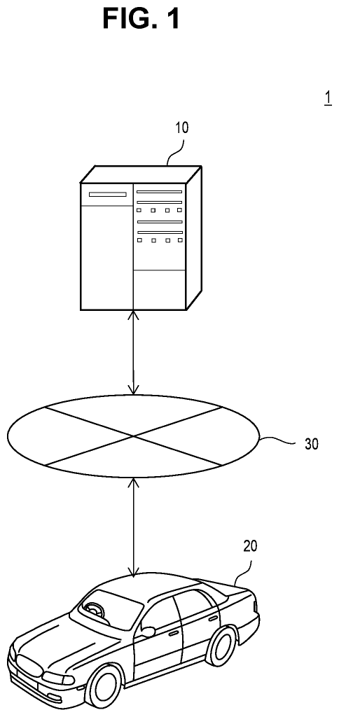

FIG. 1 is a diagram illustrating a configuration of an information processing system 1 according to the embodiment of the present disclosure. Referring to FIG. 1, a configuration and an outline of the information processing system 1 according to the embodiment of the present disclosure will be described.

The information processing system 1 includes an information processing apparatus 10 and a vehicle 20. The information processing apparatus 10 and the vehicle 20 are communicably connected to each other via a network 30. The network 30 may be a network such as a mobile communication network, or the internet.

Although FIG. 1 shows one information processing apparatus 10 and one vehicle 20, the number of the information processing apparatuses 10 and the vehicles 20 may be two or more.

The information processing apparatus 10 may be, for example, a dedicated computer configured to function as a server. The information processing apparatus 10 may be a general-purpose personal computer (PC).

The information processing apparatus 10 is able to communicate with the vehicle 20 via the network 30. The information processing apparatus 10 calculates an advertising fee of the vehicle 20 traveling while presenting the advertisement thereon. The advertising fee for the advertisement presented on the vehicle 20 is paid by an advertiser.

The information processing apparatus 10 acquires, from the vehicle 20, imaging data obtained by capturing the image of the surroundings of the vehicle 20. The information processing apparatus 10 calculates the advertising fee for the advertisement presented on the vehicle 20 based on the imaging data acquired from the vehicle 20. The information processing apparatus 10 transmits the calculated advertising fee to the vehicle 20.

The vehicle 20 can be any type of vehicle such as a gasoline vehicle, a diesel vehicle, a hybrid vehicle (HV), a plug-in hybrid vehicle (PHV), an electric vehicle (EV), or a fuel cell vehicle (FCV). The vehicle 20 is driven by a driver in the present embodiment, but may be autonomously driven at any level. The autonomous driving level may be, for example, any one of levels defined by the Society of Automotive Engineers (SAE), i.e., SAE Level 1 to SAE Level 5. The vehicle 20 may be a MaaS (Mobility-as-a-Service) vehicle.

The vehicle 20 presents the advertisement on, for example, a side of the vehicle 20. The advertisement is not limited to being presented on the side of the vehicle 20, it may be presented in a such a way that the advertisement is visible to pedestrians walking in the vicinity of the vehicle 20 without disrupting driving of the vehicle 20, for example presented on a surface of a hood or a roof. The vehicle 20 may be a commercial vehicle, for example, a taxi or a bus.

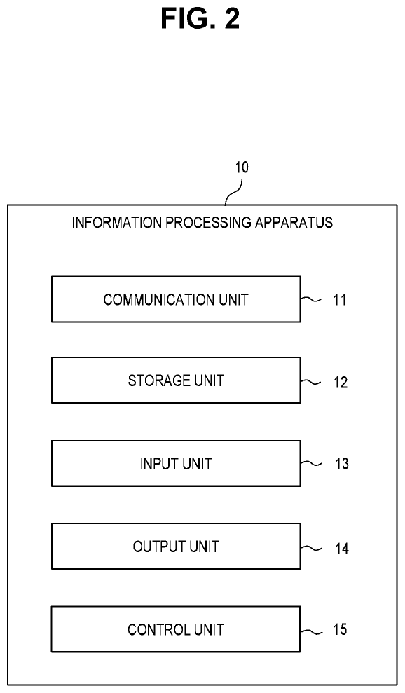

Referring to FIG. 2, a configuration of the information processing apparatus 10 according to the embodiment of the present disclosure will be described.

The information processing apparatus 10 includes a communication unit 11, a storage unit 12, an input unit 13, an output unit 14, and a control unit 15.

The communication unit 11 has a communication module connected to the network 30. For example, the communication unit 11 may include a communication module corresponding to a LAN (Local Area Network) standard. In one embodiment, the information processing apparatus 10 is connected to the network 30 via the communication unit 11. The communication unit 11 transmits and receives various types of information via the network 30. The communication unit 11 is able to communicate with the vehicle 20 via the network 30.

The storage unit 12 may be, for example, a semiconductor memory, a magnetic memory, or an optical memory, but is not limited thereto. The storage unit 12 may function as, for example, a main storage device, an auxiliary storage device, or a cache memory. The storage unit 12 stores random information used in the operation of the information processing apparatus 10. The storage unit 12 may store, for example, a system program, an application program, various types of information received by the communication unit 11, and the like. The information stored in the storage unit 12 may be updated by, for example, information received by the network 30 via the communication unit 11. A part of the storage unit 12 may be installed outside the information processing apparatus 10. In such a case, a part of the storage unit 12 installed outside may be connected to the information processing apparatus 10 via an optional interface.

The input unit 13 includes one or more input interfaces that detect a user's input and acquire input information as operated by a user. For example, the input unit 13 includes, but is not limited to, physical keys, capacitance keys, a touchscreen provided integrally with a display of the output unit 14, a microphone that accepts voice input, and the like.

The output unit 14 includes one or more output interfaces that output information to notify the user. For example, the output unit 14 includes, but is not limited to, a display that outputs information as a video, a speaker that outputs information as audio, and the like.

The control unit 15 includes at least one processor, at least one dedicated circuit, or a combination thereof. The processor is a general-purpose processor such as a central processing unit (CPU) or graphics processing unit (GPU), or alternatively, a dedicated processor specialized for specific processing. The dedicated circuit may be, for example, a field-programmable gate array (FPGA) or an application specific integrated circuit (ASIC). The control unit 15 executes processes related to the operation of the information processing apparatus 10 while controlling each unit of the information processing apparatus 10.

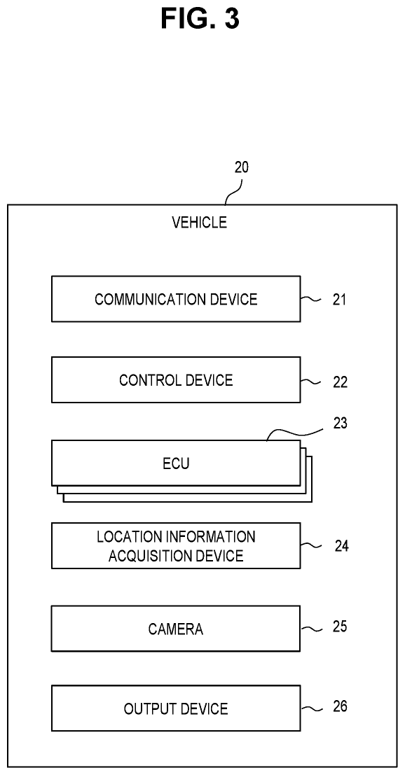

Referring to FIG. 3, a configuration of the vehicle 20 according to the embodiment of the present disclosure will be described.

The vehicle 20 includes a communication device 21, a control device 22, a plurality of electronic control units (ECUs) 23, a location information acquisition device 24, a camera 25, and an output device 26. The communication device 21, the control device 22, the ECUs 23, the location information acquisition device 24, the camera 25, and the output device 26 are connected to each other through, for example, an in-vehicle network such as a CAN (Controller Area Network) or a dedicated line, whereby those components can communicate with each other.

The communication device 21 has a communication module connected to the network 30. For example, the communication device 21 may include a communication module corresponding to a mobile communication standard such as LTE (Long Term Evolution), 4G (4th Generation), 5G (5th Generation), or the like. In one embodiment, the vehicle 20 is connected to the network 30 via the communication device 21. The communication device 21 transmits and receives various types of information via the network 30. The communication device 21 is able to communicate with the information processing apparatus 10 via the network 30.

The control device 22 includes at least one processor, at least one dedicated circuit, or a combination thereof. The processor is a general-purpose processor (such as CPU or GPU) or a dedicated processor specialized for specific processing. The dedicated circuit may be, for example, an FPGA or an ASIC. The control device 22 executes processes related to the operation of the vehicle 20 while controlling each unit of the vehicle 20.

The control device 22 receives various types of vehicle information on the vehicle 20 from, for example, each of the ECUs 23. The vehicle information includes, for example, speed, acceleration, location, headlight status, and automatic driving state. The control device 22 transmits the vehicle information to the information processing apparatus 10 via the communication device 21.

The ECUs 23 control the operation of the vehicle 20 in cooperation with the control device 22. In particular, the ECUs 23 receive a control command from the control device 22 and control the operation of the vehicle 20 according to the control command. For example, the ECUs 23 control an operation variable of the vehicle 20 such that the operation variable is a value indicated by the control command. Further, the ECUs 23 collect measured values of control variables or operation variables of the vehicle 20 from various sensors mounted on the vehicle 20, at each control timing, and transmit those values to the control device 22.

The location information acquisition device 24 includes one or more receivers corresponding to a random satellite positioning system. For example, the location information acquisition device 24 may include a GPS (Global Positioning System) receiver. The location information acquisition device 24 acquires a measured location of the vehicle 20 as location information. The location information may include, for example, an address, latitude, longitude, altitude, and the like.

The camera 25 captures the image of the surroundings of the vehicle 20. The camera 25 is installed to capture an image of pedestrians walking in the vicinity of the vehicle 20 such that it can capture at least a lateral side of the vehicle 20. The camera 25 may include an imaging device that captures visible light, or may include an imaging device that captures electromagnetic waves other than visible light, for example, infrared light. The camera 25 transmits, to the control device 22, the imaging data obtained by capturing the image of the surroundings of the vehicle 20. Although only one camera 25 is shown in FIG. 3, a plurality of the cameras 25 may be installed on the vehicle 20.

The output device 26 includes one or more output interfaces that output information to notify the user. For example, the output device 26 includes, but is not limited to, a display that outputs information as a video, a speaker that outputs information as audio, and the like.

### Operation of Information Processing System

Referring to FIGS. 1 to 3, the operation of the information processing system 1, shown in FIG. 1, will be described.

The vehicle 20 travels while presenting the advertisement thereon. The vehicle 20 may travel with the advertisement presented on, for example, the side of the vehicle 20.

The camera 25 of the vehicle 20 captures the image of the surroundings of the vehicle 20. The camera 25 may capture still images at predetermined time intervals, or may shoot videos.

When a pedestrian is walking in the vicinity of the vehicle 20, the imaging data obtained by the camera 25 capturing the image of the surroundings of the vehicle 20 includes the pedestrian walking in the vicinity of the vehicle 20.

The control device 22 transmits the imaging data obtained by the camera 25 capturing the image of the surroundings of the vehicle 20 to the information processing apparatus 10 via the communication device 21. Hereinafter, the imaging data obtained by the camera 25 capturing the image of the surroundings of the vehicle 20 may be simply referred to as “imaging data”.

The communication unit 11 of the information processing apparatus 10 receives the imaging data transmitted by the vehicle 20. The control unit 15 acquires the imaging data transmitted by the vehicle 20 via the communication unit 11.

The control unit 15 calculates the advertising fee of the advertisement presented on the vehicle 20 based on the imaging data acquired from the vehicle 20. The calculation of the advertising fee executed by the control unit 15 will be described below.

The control unit 15 conducts image analysis on the imaging data acquired from the vehicle 20 and extracts pedestrians included in the imaging data.

The control unit 15 executes a process of extracting the pedestrians included in the imaging data each time the imaging data is acquired from the vehicle 20.

The control unit 15 calculates the advertising fee of the advertisement presented on the vehicle 20 based on the number of the extracted pedestrians. The control unit 15 calculates the advertising fee based on, for example, the cumulative number of the extracted pedestrians on the day when the imaging data is acquired. In this case, the control unit 15 may calculate the advertising fee on the day when the imaging data is acquired, based on the cumulative number of the pedestrians extracted from several pieces of imaging data, acquired within a period from midnight on the day when the imaging data is acquired to the time when the latest imaging data is acquired. Moreover, in a case where the advertisement presented on the vehicle 20 can be turned on or off, the control unit 15 may calculate the advertising fee based on the cumulative number of the pedestrians extracted from the imaging data acquired within a period from the time when the advertisement is turned on to the time when the advertisement is turned off.

The period in which the control unit 15 calculates the cumulative number of pedestrians may be any period. For example, the control unit 15 may calculate the cumulative number of the pedestrians extracted from the imaging data during a week or a month.

When the advertising fee is calculated based on the number of the pedestrians extracted from the imaging data, the control unit 15 may calculate the advertising fee according to a predetermined rule mutually agreed upon by the advertiser who provides the advertisement and the service provider who owns the vehicle 20. The advertising fee may be proportional to, for example, the number of pedestrians. Alternatively, the advertising fee may be, for example, a charge obtained by combining a predetermined basic charge and a charge proportional to the number of pedestrians. Alternatively, the advertising fee may gradually increase, for example, with the number of pedestrians.

The control unit 15 transmits the calculated advertising fee to the vehicle 20 via the communication unit 11.

The communication device 21 of the vehicle 20 receives the advertising fee transmitted by the information processing apparatus 10. The control device 22 acquires the advertising fee transmitted by the information processing apparatus 10 via the communication device 21.

The control device 22 causes the output device 26 to output the acquired advertising fee. The control device 22 displays, for example, the acquired advertising fee on the display included in the output device 26.

When the advertising fee is displayed on the output device 26, a driver of the vehicle 20 can confirm, in real time, the advertising fee obtained by showing the advertisement on the vehicle 20. Since the advertising fee increases as the number of the pedestrians included in the imaging data captured by the camera 25 increases, the driver can, by learning the advertising fee, be motivated to travel in a place with many pedestrians.

### Weighting Number of Pedestrians

When the advertising fee is calculated based on the number of the pedestrians extracted from the imaging data, the control unit 15 of the information processing apparatus 10 may weight the number of the pedestrians based on the various types of data before calculating the advertising fee. Some examples of weighting the number of pedestrians will be described below.

### Weighting by Vehicle Speed

The control device 22 of the vehicle 20 acquires speed data of the vehicle 20 from the ECU 23. When the imaging data is transmitted to the information processing apparatus 10, the control device 22 transmits, to the information processing apparatus 10, the speed data of the vehicle 20 when the imaging data is captured, together with the imaging data.

The control unit 15 of the information processing apparatus 10 acquires the speed data transmitted by the vehicle 20 together with the imaging data via the communication unit 11. When the advertising fee is calculated based on the number of the pedestrians extracted from the imaging data, the control unit 15 weights the number of the pedestrians based on the speed data of the vehicle 20 when the imaging data is captured.

The control unit 15 weights the number of the pedestrians such that a weighting value relatively decreases as the speed of the vehicle 20 increases. The control unit 15 may continuously change the weighting value depending on the speed of the vehicle 20, or may change the weighting value in a stepped manner.

As stated above, the higher the speed of the vehicle 20, the smaller the weighting value is, such that the counted number of the pedestrians is relatively smaller when the speed of the vehicle 20 is higher when the imaging data is captured. On the other hand, when the speed of the vehicle 20 is lower when the imaging data is captured, the counted number of the pedestrians is relatively larger. This is based on the principle that the pedestrians can see the advertisement presented on the vehicle 20 better when the speed of the vehicle 20 is lower than when the speed of the vehicle is higher. Therefore, the control unit 15 can consider the principle stated above and calculate the advertising fee in relation to the effect of the advertisement.

### Weighting by Distance Between Vehicle and Pedestrians

When the image analysis is conducted on the imaging data acquired from the vehicle 20 to extract the pedestrians included in the imaging data, the control unit 15 of the information processing apparatus 10 also calculates a distance between a pedestrian and the vehicle 20 by the image analysis.

When the advertising fee is calculated based on the number of the pedestrians extracted from the imaging data, the control unit 15 weights the number of the pedestrians based on the distance between each pedestrian and the vehicle 20.

When the number of the pedestrians is extracted, the control unit 15 sets the weighting value to zero for, for example, pedestrians that are farther from the vehicle 20 than a predetermined distance threshold, such that those pedestrians are not included in the number of the pedestrians extracted from the imaging data.

Alternatively, when the number of the pedestrians is extracted, the control unit 15 may weight the number of the pedestrians such that the weighting value relatively increases as the distance between each pedestrian and the vehicle 20 is shorter.

The weighting based on the distance between a pedestrian and the vehicle 20 is based on the principle that a pedestrian who is far from the vehicle 20 can fail to clearly see the advertisement presented on the vehicle 20. Therefore, the control unit 15 can consider the principle stated above and calculate the advertising fee in relation to the effect of the advertisement.

Weighting by Lane where Vehicle is Traveling

The control device 22 of the vehicle 20 acquires the location information of the vehicle 20 from the location information acquisition device 24. The control device 22 determines a lane in which the vehicle 20 is traveling based on the acquired location information and map information. For example, when a road on which the vehicle 20 is traveling has two lanes, the control device 22 determines whether the vehicle is traveling in a left lane or a right lane. The control device 22 may acquire the map information from, for example, a map server connected to the network 30, via the communication device 21. When the imaging data is transmitted to the information processing apparatus 10, the control device 22 transmits, to the information processing apparatus 10, lane data indicating the lane in which the vehicle 20 is traveling when the imaging data is captured, together with the imaging data.

The control unit 15 of the information processing apparatus 10 acquires the lane data transmitted by the vehicle 20 together with the imaging data via the communication unit 11. When the advertising fee is calculated based on the number of the pedestrians extracted from the imaging data, the control unit 15 weights the number of the pedestrians based on the lane data indicating the lane in which the vehicle 20 is traveling when the imaging data is captured.

The control unit 15 weights the number of the pedestrians such that the weighting value relatively increases when the vehicle 20 is traveling in the left lane.

As stated above, the weighting value is relatively larger when the vehicle 20 is traveling in the left lane, such that the counted number of the pedestrians is relatively larger when the vehicle 20 is traveling in the left lane when the imaging data is captured. On the other hand, when the vehicle 20 is traveling in a lane other than the left lane when the imaging data is captured, the counted number of the pedestrians is relatively smaller. This is based on the principle that the pedestrians can see the advertisement presented on the vehicle 20 better when the vehicle 20 is traveling in the left lane. Therefore, the control unit 15 can consider the principle stated above and calculate the advertising fee in relation to the effect of the advertisement.

Weighting by which Side of Vehicle Pedestrian is Passing

When the imaging data is transmitted to the information processing apparatus 10, the control device 22 of the vehicle 20 transmits, to the information processing apparatus 10, data indicating which side of the vehicle 20 the imaging data is captured on, together with the imaging data. The control device 22 may determine, for example, which side of the vehicle 20 the imaging data is captured on, based on a position at which the camera 25 is installed.

When the advertising fee is calculated based on the number of the pedestrians extracted from the imaging data, the control unit 15 of the information processing apparatus 10 weights the number of the pedestrians based on the data indicating which side of the vehicle 20 the imaging data is captured on.

The control unit 15 weights the number of the pedestrians such that the weighting value relatively increases when the imaging data is captured on the left side of the vehicle 20.

As stated above, the weighting value is relatively larger when the imaging data is captured on the left side of the vehicle 20, such that the counted number of the pedestrians passing the left side of the vehicle 20 is relatively larger. On the other hand, the counted number of the pedestrians passing the right side of the vehicle 20 is relatively smaller. This is based on the principle that the pedestrians passing the left side of the vehicle 20 can more clearly see the advertisement presented on the vehicle 20. Therefore, the control unit 15 can consider the principle stated above and calculate the advertising fee in relation to the effect of the advertisement.

### Weighting by Time

When the imaging data is transmitted to the information processing apparatus 10, the control device 22 transmits, to the information processing apparatus 10, time data indicating a time when the imaging data is captured, together with the imaging data.

The control unit 15 of the information processing apparatus 10 acquires the time data transmitted by the vehicle 20 together with the imaging data via the communication unit 11. When the advertising fee is calculated based on the number of the pedestrians extracted from the imaging data, the control unit 15 weights the number of the pedestrians based on the time data indicating the time when the imaging data is captured.

When the number of the pedestrians is extracted, the control unit 15 sets the weighting value to zero, for example, in a case where the imaging data is captured at night, such that the pedestrians included in such imaging data are not included in the number of the pedestrians extracted from the imaging data. The control unit 15 may determine whether the imaging data is captured at night based on, for example, whether the time when the imaging data is captured is later than a predetermined time threshold.

Alternatively, the control unit 15 may determine whether the imaging data is captured at night based on, for example, whether headlights of the vehicle 20 are turned on or off. In this case, the control device 22 of the vehicle 20 acquires, from the ECU 23, information indicating whether the headlights of the vehicle 20 are turned on or off and transmits the information to the information processing apparatus 10. When the number of the pedestrians is extracted, the control unit 15 may set the weighting value to zero, for example, in a case where the headlights of the vehicle 20 are turned on, such that the pedestrians included in the imaging data are not included in the number of the pedestrians extracted from the imaging data.

Alternatively, the control unit 15 may determine whether the imaging data is captured at night based on, for example, the detection result of an illuminance sensor installed on the vehicle 20. In this case, the control device 22 of the vehicle 20 acquires the detection result from the illuminance sensor and transmits the detection result to the information processing apparatus 10. When the number of the pedestrians is extracted, the control unit 15 may set the weighting value to zero, for example, in a case where the detection result from the illuminance sensor of the vehicle 20 is equal to or less than a predetermined illuminance threshold, such that the pedestrians included in the imaging data are not included in the number of the pedestrians extracted from the imaging data.

The weighting based on the time when the imaging data is captured is based on the principle that the pedestrians cannot clearly see the advertisement presented on the vehicle 20 at night. Therefore, the control unit 15 can consider the principle stated above and calculate the advertising fee in relation to the effect of the advertisement.

The control unit 15 may carry out only one weighting or a combination of two or more from among the examples of weighting stated above.

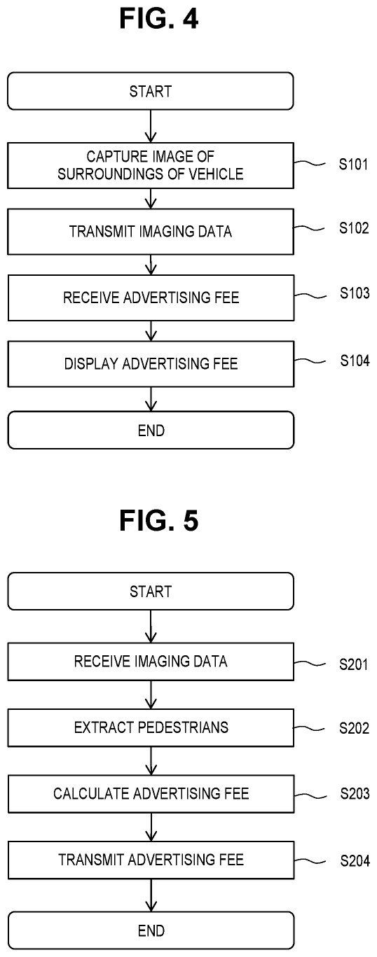

Referring to FIGS. 4 and 5, the operation of the information processing system 1 will be described. FIG. 4 is a flowchart mainly illustrating the operation of the vehicle 20. FIG. 5 is a flowchart mainly illustrating the operation of the information processing apparatus 10.

The camera 25 of the vehicle 20 captures the image of the surroundings of the vehicle 20 in step S101 of FIG. 4.

The control device 22 of the vehicle 20 transmits the imaging data obtained by the camera 25 capturing the image of the surroundings of the vehicle 20 to the information processing apparatus 10 via the communication device 21 in step S102 of FIG. 4.

The communication unit 11 of the information processing apparatus 10 receives the imaging data transmitted by the vehicle 20 in step S201 of FIG. 5. The control unit 15 acquires the imaging data transmitted by the vehicle 20 via the communication unit 11.

The control unit 15 of the information processing apparatus 10 conducts the image analysis on the imaging data acquired from the vehicle 20 and extracts pedestrians included in the imaging data in step S202 of FIG. 5.

The control unit 15 of the information processing apparatus 10 calculates the advertising fee of the advertisement presented on the vehicle 20 based on the number of the extracted pedestrians in step S203 of FIG. 5.

The control unit 15 of the information processing apparatus 10 transmits the calculated advertising fee to the vehicle 20 via the communication unit 11 in step S204 of FIG. 5.

The communication device 21 of the vehicle 20 receives the advertising fee transmitted by the information processing apparatus 10 in step S103 of FIG. 4. The control device 22 acquires the advertising fee transmitted by the information processing apparatus 10 via the communication device 21.

The control device 22 of the vehicle 20 displays the acquired advertising fee on the display included in the output device 26 in step S104 of FIG. 4.

As stated above, in the information processing apparatus 10 according to the present embodiment, the control unit 15 acquires the imaging data obtained by capturing the image of the surroundings of the vehicle 20 traveling while presenting the advertisement, and calculates the advertising fee of the advertisement presented on the vehicle 20, based on the imaging data acquired. Accordingly, the information processing apparatus 10 according to the present embodiment can calculate the advertising fee in relation to the effect of the advertisement based on a situation around the vehicle 20 which can be determined from the imaging data obtained by capturing the image of the surroundings of the vehicle 20, instead of calculating the advertising fee as a fixed fee.

Therefore, the information processing apparatus 10 according to the present embodiment can correlate the advertising fee of the advertisement presented on the vehicle 20 with the effect of the advertisement.

The present disclosure is not limited to the embodiments stated above. For example, a plurality of blocks described in the block diagram may be integrated, or alternatively, a single block may be divided into several blocks. Instead of executing the steps described in the flowchart in chronological order according to the description, the steps may be executed in parallel or in a different order depending on the processing capability of the device executing the steps, or as necessary. Other changes or modifications can be made without departing from the gist of the present disclosure.

For example, any part of processing operations executed in the information processing apparatus 10 in the embodiment stated above may be executed in the vehicle 20. Alternatively, any part of the processing operations executed in the vehicle 20 may be executed in the information processing apparatus 10.

For example, it is also possible to employ a configuration in which a general-purpose electronic device such as a smartphone or a computer functions as the information processing apparatus 10 according to the embodiment stated above. In particular, a program describing processing contents for implementing each function of the information processing apparatus 10 and the like according to the embodiment is stored in the memory of the electronic device, and the program is read and executed by a processor of the electronic device. Therefore, the disclosure according to one embodiment can also be implemented as a program that can be executed by a processor.

For example, the vehicle 20 has been described as being a commercial vehicle in the embodiment stated above, but the vehicle 20 is not limited thereto. The vehicle 20 may be a private car.

For example, the information processing apparatus 10 has been described as being mounted on the vehicle 20 in the embodiment stated above. At this time, the information processing apparatus 10 may communicate directly with the vehicle 20, instead of via the network 30.

What is claimed is:

1. An information processing apparatus comprising:
a control unit configured to:
acquire imaging data obtained by capturing an image of surroundings of a vehicle traveling while presenting an advertisement; and
calculate an advertising fee of the advertisement based on the imaging data.

2. The information processing apparatus according to claim 1, wherein the control unit is configured to:
extract pedestrians included in the imaging data by an image analysis; and
calculate the advertising fee of the advertisement based on the number of extracted pedestrians.

3. The information processing apparatus according to claim 2, wherein the control unit is configured to:
further acquire speed data of the vehicle when the imaging data is captured from the vehicle; and
calculate the advertising fee based on the speed data and the number of pedestrians.

4. The information processing apparatus according to claim 2, wherein the control unit is configured to:
calculate a distance between the vehicle and a pedestrian included in the imaging data by the image analysis; and
calculate the advertising fee based on the distance and the number of the extracted pedestrians.

5. The information processing apparatus according to claim 2, wherein the control unit is configured to:
further acquire lane data indicating a lane in which the vehicle is traveling when the imaging data is captured from the vehicle; and
calculate the advertising fee based on the lane data and the number of the pedestrians.

6. The information processing apparatus according to claim 2, wherein the control unit is configured to:
further acquire time data indicating a time when the imaging data is captured from the vehicle; and
calculate the advertising fee based on the time data and the number of the pedestrians.

7. A vehicle equipped with the information processing apparatus according to claim 1.

8. An information processing system comprising:
the information processing apparatus according to claim 1; and
a vehicle equipped with a camera configured to capture an image of surroundings of the vehicle.

9. A program causing a computer to execute:
acquiring imaging data obtained by capturing an image of surroundings of a vehicle traveling while presenting an advertisement; and
calculating an advertising fee of the advertisement based on the imaging data.

10. The program according to claim 9, wherein the calculation of the advertising fee includes:
extracting pedestrians included in the imaging data by an image analysis; and
calculating the advertising fee of the advertisement based on the number of the extracted pedestrians.

11. The program according to claim 10, further causing the computer to execute:
acquiring speed data of the vehicle when the imaging data is captured from the vehicle,
wherein the calculation of the advertising fee includes calculating the advertising fee based on the speed data and the number of the pedestrians.

12. The program according to claim 10, further causing the computer to execute:
calculating a distance between the vehicle and a pedestrian included in the imaging data by the image analysis,
wherein the calculation of the advertising fee includes calculating the advertising fee based on the distance and the number of the pedestrians.

13. The program according to claim 10, further causing the computer to execute:
acquiring lane data indicating a lane in which the vehicle is traveling when the imaging data is captured from the vehicle,
wherein the calculation of the advertising fee includes calculating the advertising fee based on the lane data and the number of the pedestrians.

14. The program according to claim 10, further causing the computer to execute:
acquiring time data indicating a time when the imaging data is captured from the vehicle,
wherein the calculation of the advertising fee includes calculating the advertising fee based on the time data and the number of the pedestrians.

15. An information processing method used in an information processing apparatus, the information processing method comprising:
acquiring imaging data obtained by capturing an image of surroundings of a vehicle traveling while presenting an advertisement; and
calculating an advertising fee of the advertisement based on the imaging data.

16. The information processing method according to claim 15, wherein the calculation of the advertising fee includes:
extracting pedestrians included in the imaging data by an image analysis; and
calculating the advertising fee of the advertisement based on the number of the extracted pedestrians.

17. The information processing method according to claim 16, further comprising:
acquiring speed data of the vehicle when the imaging data is captured from the vehicle,
wherein the calculation of the advertising fee includes calculating the advertising fee based on the speed data and the number of the pedestrians.

18. The information processing method according to claim 16, further comprising:
calculating a distance between the vehicle and the pedestrian included in the imaging data by the image analysis,
wherein the calculation of the advertising fee includes calculating the advertising fee based on the distance and the number of the pedestrians.

19. The information processing method according to claim 16, further comprising:
acquiring lane data indicating a lane in which the vehicle is traveling when the imaging data is captured from the vehicle,
wherein the calculation of the advertising fee includes calculating the advertising fee based on the lane data and the number of the pedestrians.

20. The information processing method according to claim 16, further comprising:
acquiring time data indicating a time when the imaging data is captured from the vehicle,
wherein the calculation of the advertising fee includes calculating the advertising fee based on the time data and the number of the pedestrians.
